(19) United States
(12) Patent Application Publication
(10) Pub. No.: US 2012/0038515 A1
(43) Pub. Date: Feb. 16, 2012

(54) ARM-WORN RFID READER

(76) Inventors: Patrick W. Truitt, Mars, PA (US); Vinh-duy Thai Nguyen, Pittsburgh, PA (US); Rob Vargo, Monroeville, PA (US); Matthew Shope, Beaver Falls, PA (US)

(21) Appl. No.: 12/853,684

(22) Filed: Aug. 10, 2010

(51) Int. Cl. H01Q 1/24; H01Q 1/48

(52) U.S. Cl. 343/702; 343/848

(57) ABSTRACT

An RFID reader is configured to be worn on the arm of a user and includes a housing with a bottom surface for facing the arm of a user and a top surface facing away from the arm. A securement structure engages the arm of the user to secure the housing. An antenna is mounted within the housing and is angled with respect to the bottom surface of the housing for providing an RF field at an angle to the arm of a user to direct the RF field toward an item held by the arm. The antenna includes an indexing structure with multiple angular positions for orientation of the antenna. A key structure is positioned in the housing and configured for engaging the indexing structure at an angular position around the antenna to orient the antenna at a desired rotational orientation in the housing to tune the antenna. Grip structures are formed along the top surface of the housing for gripping an item held by a user that contains an RFID tag that is read by the RFID reader.

### TECHNICAL FIELD

This invention relates generally to devices for reading radio frequency identification (“RFID”) tags, and more specifically, to a device that can be worn on the arm of a user for detecting RFID tags on packages.

### BACKGROUND OF THE INVENTION

Storage and management of inventory is a critical function of many businesses, including the manufacturing, retail, and shipping industries. For efficiency purposes, it is desirable to communicate product information to a centralized inventory tracking system as the product is being removed or placed on shelves, rather than requiring a separate entry of product information at a central location after removal or placement of the product.

One conventional method for communicating product information to an inventory tracking system uses radio frequency identification (RFID) tags that are placed on the products and portable RFID readers that are carried by the workers handling the products. An RFID tag includes a microchip with data, an antenna, and sometimes a power source such as a battery (e.g., active RFID tag). An RFID reader also has an antenna, and the RFID reader's antenna transmits electromagnetic energy, when energized, in the form of an RF beam or radio wave to the vicinity of the RFID tags. Each RFID tag that is located within the range of the RFID reader then energizes and sends identification information or other data back to the RFID reader via RF radio signals. The data/information is then further processed, such as by another electronic device.

RFID tags, because they radiate their information as radio signals, may be read without having a line-of-sight arrangement between an RFID reader and a tag. However, many RFID readers focus their RF beam so that only RFID tags close to the RFID reader are detected. Therefore, in conventional RFID readers, the focused RF beam emitted from the RFID reader may only actuate RFID tags within a few inches of the RFID reader. Consequently, inventory workers have had to pass the RFID reader directly over an RFID tag on a package or item to obtain a proper reading of the product information. Even if the RFID reader is configured to be worn on the hand or arm of the worker, the worker has to separately pass his hand or arm over the RFID tag before picking up or moving the package or item. This process is inefficient and can be frustrating for a worker.

Therefore, it would be desirable to provide an improved RFID reader that addresses the shortcomings of conventional RFID readers. It is further desirable to provide an RFID reader that is easily handled and used, when handling items of packages.

### SUMMARY OF THE INVENTION

The invention according to one embodiment includes an RFID reader configured to be worn on the arm of a user and including a housing having a bottom surface for facing the arm of a user and a top surface facing away from the arm. A securement structure is configured to engage the arm of the user to secure the housing to the arm. An antenna having a directional field is mounted within the housing and is angled with respect to the bottom surface of the housing to orient the directional field. The angled antenna provides an RF field at an angle to the arm of a user to direct the RF field toward a package held by the arm to scan for an RFID tag on the package. In one possible embodiment, the directional field antenna is a helical antenna. In a further embodiment, the helical antenna may be a helical fractal antenna that is angled with respect to a plane of the bottom surface at an angle around 5 degrees.

In another embodiment, an RFID reader includes a housing and a helical antenna mounted in the housing. The helical antenna includes an indexing structure with multiple angular positions for orientation of the antenna. One or more key structures are positioned in the housing and configured for engaging the indexing structure at an angular position around the antenna to orient the helical antenna at a desired rotational orientation in the housing to tune the helical antenna. In one embodiment, the indexing structure includes slots formed in a ground plane of the antenna, around the periphery of the ground plane.

The RFID reader in another embodiment includes a housing with a bottom surface for facing the arm of a user and a top surface facing away from the arm. A securement structure engages the arm of the user to secure the housing to the arm. A grip structure is located on a portion of the top surface. The grip structure is configured for gripping a surface of a package when it is held in the arms of a user using the RFID reader.

### BRIEF DESCRIPTION OF THE DRAWINGS

The accompanying drawings, which are incorporated in and constitute a part of this specification, illustrate an embodiment of the invention and, together with a general description of the invention given below, serve to explain the principles of the invention.

FIG. 1 is a top view of RFID readers according to one embodiment of the invention, schematically illustrating the scanning area as a user handles an item.

FIG. 2 is a top view similar to FIG. 1 with a user carrying an item to be read by the RFID readers of Figure.

FIG. 3 is a perspective view of an RFID reader in accordance with an embodiment of the invention.

FIG. 3A is an exploded view of a portion of the RFID reader housing.

FIG. 4 is a perspective view of a portion of a housing for the RFID reader of FIG. 3, illustrating internal components.

FIG. 5 is a cross-sectional side view of the RFID reader of FIG. 3.

FIG. 5A is a schematic of the electronic components of an RFID reader in accordance with one embodiment of the invention.

FIG. 6A is a perspective view of the helical member of the helical antenna in accordance with one embodiment of the invention.

FIG. 6B is another perspective view of a helical antenna in accordance with one embodiment of the invention.

FIG. 7 is a perspective view of the helical antenna accordance with one embodiment of the invention

FIG. 8 is a perspective view of an RFID reader in accordance with an embodiment of the invention.

### DETAILED DESCRIPTION OF EMBODIMENTS OF THE INVENTION

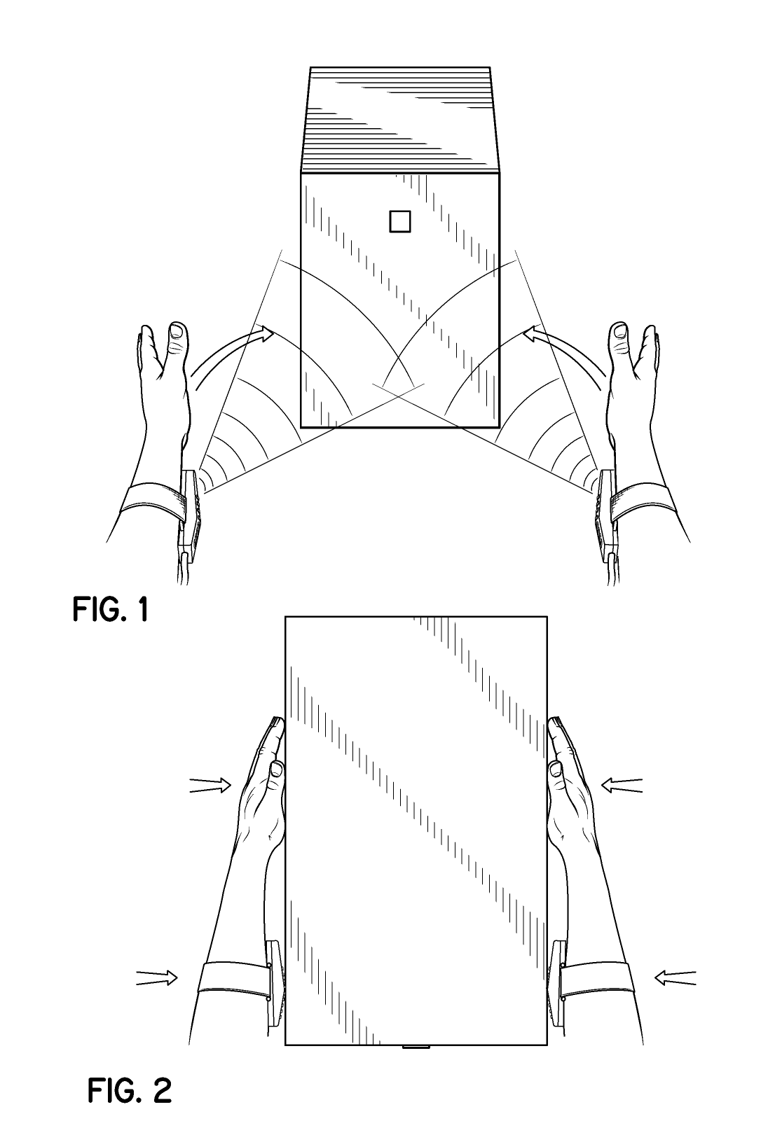

Referring to FIGS. 1-2, use of one embodiment of an RFID reader 10 for identifying a radio frequency identification (“RFID”) tag 12 attached to an item or package 14 is illustrated. As shown in FIG. 1, a worker or other user 16 managing the inventory of a business (e.g., filling orders, restocking shelves, etc.), moves around an area where an inventory of items and associated RFID tags are located. While one exemplary embodiment of the RFID reader of the invention, as disclosed herein, might be useful for managing an inventory of items, it will be generally understood that the invention has applicability in any environment where RFID tags are used. Therefore, the invention is not at all limited to inventory uses that are described herein to illustrate embodiments of the invention.

In the illustrated example of FIGS. 1 and 2, the worker 16 may pick up a specific item or package 14, such as a box, in order to move the item 14 to a cart, shelf, or some other location. The worker 16 wears one or more RFID readers 10 on their arms 18 so that the RFID readers 10 are in use as the worker 16 grasps the item 14. In accordance with one aspect of the invention, each RFID reader 10 emits an RF signal in a focused area 20 extending in front of and between the worker's hands 22. Thus, as the item 14 and the corresponding RFID tag 12 are grasped and come into the focused area 20, the RFID readers 10 capture the identification information of the tag 12 for the specific item 14. The captured information may be used or processed further by a portable electronic device and/or remote system, such as a central inventory management system. The captured data from the RFID tag is used to provide information regarding the item, for example, to determine the disposition of the item 14, or otherwise track movement of items so that the inventory records remain accurate. In this regard, the worker 16 can collect identification information about an item 14 and pick up the item 14 simultaneously without needing to stop and perform a separate read operation by passing the RFID readers 10 over the RFID tag 12. It will be understood that only one RFID reader 10 may be worn by the worker 16 in some applications within the scope of this invention.

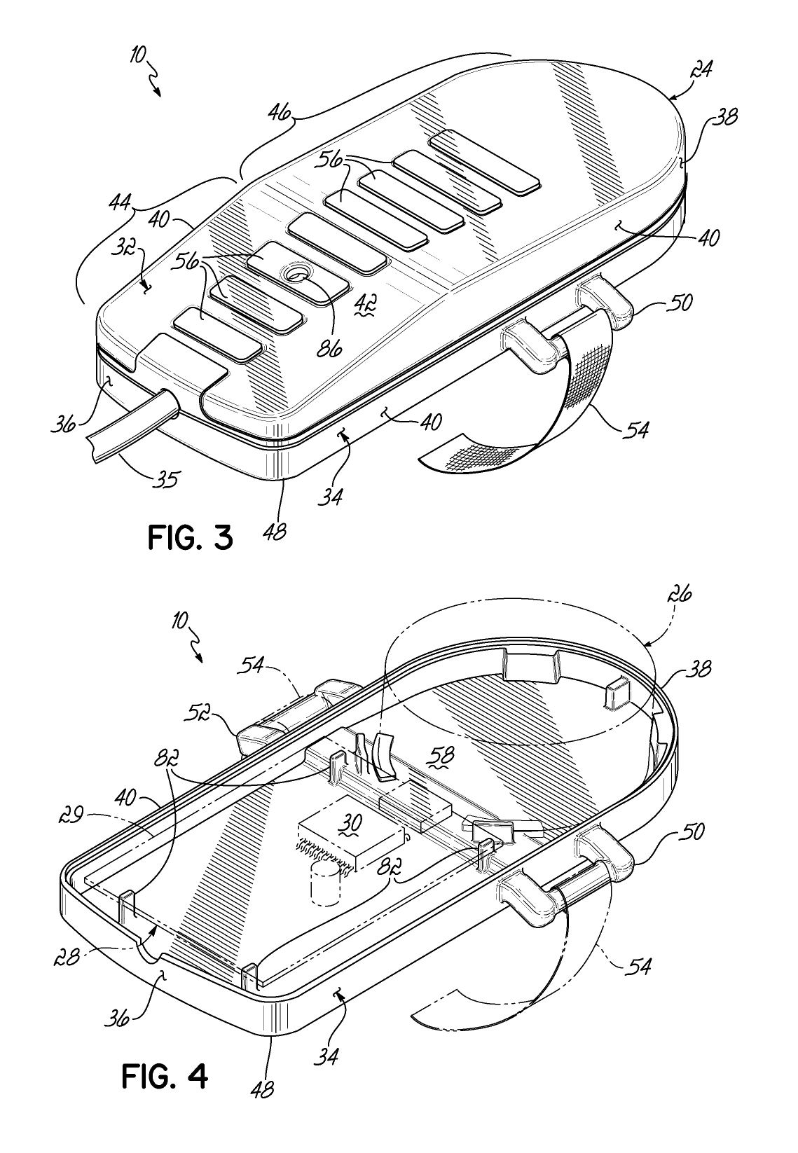

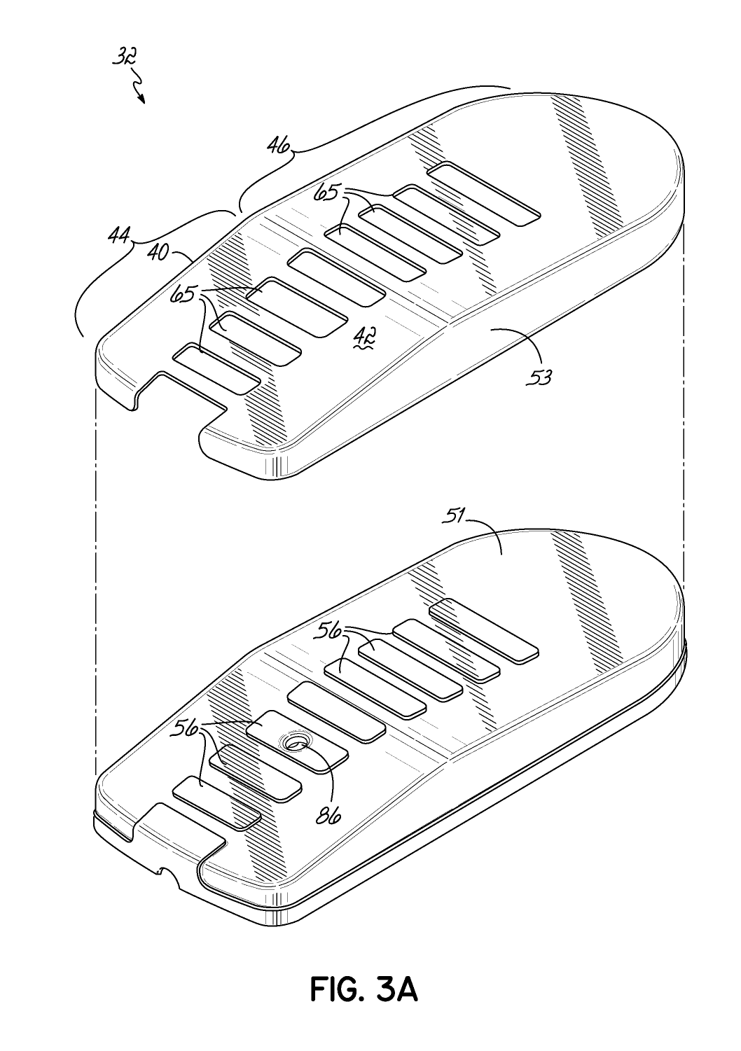

Referring to FIGS. 3-5, the RFID reader 10 in one embodiment of the invention includes a housing 24 configured to be worn on the arm of a user. The housing 24 contains an antenna 26 and suitable processing circuitry 28 controlled by a processor circuit 30 for implementing the RFID read functionality of the reader 10. In some embodiments of the invention, the processor 30 and processing circuitry 28 might also provide an RFID-write functionality in the RFID reader of the invention. Therefore, the term “RFID reader” is not limited to only a read functionality, but refers to devices that read or write or do both functions.

The housing 24, in one possible embodiment, is in the form of a two-piece shell, which includes a top housing shell 32 and a bottom housing shell 34. FIG. 3A illustrates one possible top housing shell 32 having a lower section 51 and an upper section 53 in the form of an over-mold. The lower section 51 might be formed of a suitable thermoplastic elastomer, such as Versollan OM 1225NX-1 from GLS of McHenry Ill., for example, to provide a lift assistance feature as noted below. The lower section 51 includes grip structures 56 formed into lower section, such as by being molded therein. The grip structures provide lifting assistance to a user of the invention as noted. The upper section 53 is formed of a suitable thermoplastic, such as Lexan EXL 9330 from SABIC of Pittsfield, Mass., for example. The upper section has a series of slots 65 formed therein to accommodate the grip structures 56 as illustrated in FIG. 3 and the grip structures are dimensioned in height to rise above a top surface of the upper section 53 so as to engage a box or item when the RFID reader is worn by a user who is lifting the box or item.

The use of a thermoplastic elastomer to form a portion of the housing, and specifically to form the lower section 51 of the top housing shell 32 that sits over the antenna, provides a distinct advantage to the invention. The size and power of the antenna may be reduced using the unique housing of the invention. Specifically, the thermoplastic elastomer forming the lower section and grip structures has a lower dielectric constant than the thermoplastic of the upper section 53. Therefore, the combined thickness of the housing shell 32, with part of the thickness represented by the thermoplastic elastomer, presents a lower RF weighting on the antenna. This allows for a smaller antenna and less antenna power wattage to produce the same RF field strength than would be necessary for an antenna that would be totally housed in a housing made of thermoplastic of the same total wall thickness as provided by the top housing shell 32. Therefore, in addition to providing the desired lift or grip assistance in accordance with the invention, the multipart housing also reduces the size of the RFID reader.

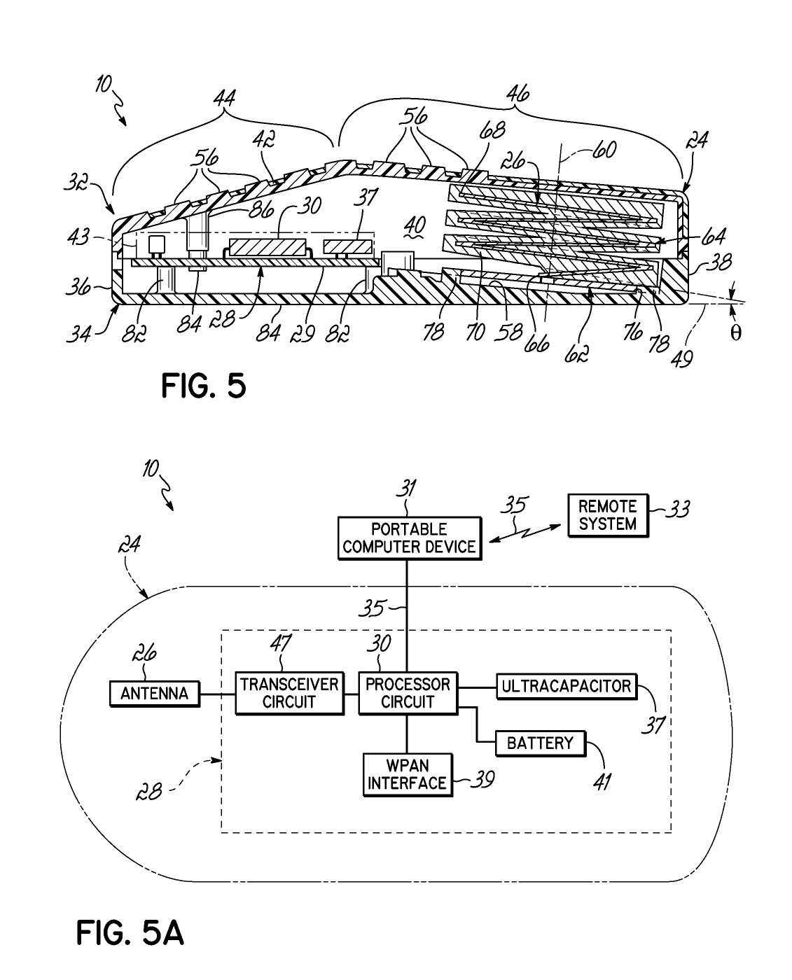

The housing has a rear surface 36, a rounded front surface 38, and a pair of lateral side surfaces 40. The front surface 38 is rounded to avoid snags against any item package 14 held by and handled by the worker 16. The top housing shell 32 also includes a top surface 42 that includes a first portion 44 and a second portion 46 angled with respect to the first portion 44. The first portion 44 of surface 42, which forms a rear section of the housing, is angled so as to not present too sharp of a transition at the rear of RFID reader 10 so as to facilitate easier handling of items and avoid snaps on the RFID reader 10. The housing 24, and particularly bottom housing shell 34, includes a bottom surface 48 configured to engage the arm 18 of a worker 16 when the RFID reader 10 is worn. Bottom surface 48 is generally flat to lie against an arm and bottom surface 48 defines a plane 49 as shown in FIG. 5. The top housing shell 32 and the bottom housing shell 34 are configured to snap together or otherwise come together to form the housing.

To secure the reader 10 to the arm of a user, the RFID reader includes a securement structure. The securement structure is configured to engage the arm of a user and to secure the housing 24 to the arm. In the embodiment in FIGS. 3, 4, the housing includes retaining members 50, 52 that can be used with a securement structure such as a strap 54. The bottom housing shell 34 including first and second retaining members 50, 52 that are fixed to or integral with housing 24 and is shown as extending outwardly from respective side surfaces 40. Such retaining members 50, 52 might also be part of or fixed to the top shell 32 or otherwise integrated into the housing 24. In the embodiment of FIG. 8, as discussed below, a separate securement structure in the form of a frame structure is used, and is configured to engage a user's arm. The housing removably couples with the separate frame structure to secure the RFID reader housing 24 to the arm or clasps. A strap 54 is coupled to one or both of the first and second retaining members 50, 52 and may extend over the bottom surface 48 of the housing 24. The straps 54 are configured to wrap around the arm 18 of a worker 16, as most clearly shown in FIGS. 1 and 2. The strap 54 may be formed of suitable stretchable material, such as neoprene material and may include a hook and loop fastener, such as Velcro® or clasps, to secure and tighten the strap 54 and the reader 10 onto the arm 18. Other securement structures and strap materials might also be used. Thus, the reader 10 can be easily mounted and removed from a worker's arm 18 as necessary.

FIG. 8 illustrates, in an alternative embodiment of the invention, wherein the securement structure is in the form of a frame structure 57 for holding the housing 24 of the RFID reader. Frame structure 57 is configured for removable coupling with housing 24 to secure the housing to the frame structure, and thus, to the arm of a user. Frame structure 57 includes one or more straps 55, and may be formed of a suitable material, such as an elastic or neoprene material. Suitable fasteners 59, such as buckles or clasps or hook/loop fasteners, might be used to secure the straps 55 together, around the arm of a user to thereby hold the frame 57 and RFID reader to the arm of a user. Frame 57 includes rounded end portions 61, 63, which are tapered or rounded so as not to create a snag when the RFID reader and frame structure 57 are in use. The frame structure 57 is formed of a suitable material so as not to interfere with the RF field generate by the intent of the RFID reader.

In accordance with one embodiment of the invention, the RFID reader incorporates a helical antenna that is angled with respect to the housing. As shown most clearly in FIG. 5, the bottom surface 48 of housing 24 is generally planar, and defines a plane 49. Plane 49 defines an engagement plane for bottom surface 48, which aligns with a surface of the worker's arm 18. In one embodiment of the invention, the first portion 44 of the top surface 42 is angled with respect to the bottom surface 48 and plane 49 in the illustrated embodiment for use against a box or item carried by a user. The portion 44 might be angled between 0 and 90 degrees. In one embodiment, surface portion 44 might be angled at an angle of approximately 15 degrees, with respect to plane 49 to form a smooth transition down to a users arm. As illustrated in FIGS. 1 and 2, when a user wears reader 10, surface portion 44 faces rearwardly, and will be pressed to the side of an item, such as a box or package, when the user grabs the item 14, as illustrated in FIG. 2.

Surface portion 46 overlies the antenna 26 of the reader, and thus, faces forwardly in the housing when a package is grabbed, as illustrated in FIG. 2. The angled antenna 26 directs the antenna electromagnetic field 20 forwardly and angled toward the RFID tag 12. The portion 46 of the top surface is also angled with respect to bottom surface 48 and plane 49. The surface portion 46 might be angled with respect to plane 49 in the range of 0-10 degrees. The angle of surface portion 46 is generally around 5 degrees, and coincides with the angle orientation of antenna 26 in accordance with one aspect of the invention. When surface 48 of the reader lies flat against the arm of a user, and top surface portion 42 is pressed against the side of an item, surface portion 46, and antenna 26, are angled with respect to the item. This angling provides a desired directivity to the RF field 20 of the antenna for more efficiently reading information from an RFID tag or otherwise engaging the RFID tag with the antenna field.

In accordance with one aspect of the invention, to assist in gripping an item, the top surface 42 of the housing as formed by the lower and upper sections 51, 53 includes at least one grip structure and, in one embodiment, a plurality of grip structures 56, which extend along the top surface 42. For example, the, the grip structures may be positioned on surface portion 44 and along part of the surface portion 46. The grip structures 56 are preferably formed of a tacky substance, such as rubber, or some other plastic elastomer material and are configured for gripping a surface of an item, such as a box or package, when the items is held in the arms of a user as illustrated in FIGS. 1-2. As discussed above, one suitable material for forming the grip structures 56 is a thermoplastic elastomer. When a worker grabs the item 14, as illustrated in FIG. 2, the grip structures 56 define a frictional gripping surface to assist the hands 22 of the worker in holding the item 14. Therefore, the grip structures ergonomically assist the worker in grasping and moving packages, while the RFID reader is operational to read information from an RFID tag. In the illustrated embodiment, the grip structure 56 is in the form of a plurality of elongated strips 56 of material. However, grip structure 56 could take other forms as well.

In accordance with another aspect of the invention, antenna 26 is an antenna that has a directional field and that is oriented to aim the directional field at an item held by a user. The antenna 26 is tilted or fixed at an angled position within the housing of the RFID reader to direct or orient the directional RF field of the antenna to a desired direction when the RFID reader is worn by a user. This angular position or orientation of the antenna 26 permits the focused RF field area 20 to more appropriately engage or scan RFID tags 12 on the item 14. In this regard, the reader 10 can reliably scan for an RFID tag 12 on an item while the worker handles the item and the grip structures 56 ergonomically assists the worker's hands 22 in holding the item 14.

The antenna 26 and its angled position or orientation are more clearly illustrated in FIGS. 5 and 7. The antenna 26 includes a ground plane member 62, such as a ground plane circuit board having a metal ground layer. The antenna element 64 extends upwardly from the ground plane member 60. A ground end 66 of the antenna element 64 is electrically coupled to the ground plane member 62. In one possible embodiment of the invention as illustrated in the drawing figures, the antenna is a helical antenna that has a directional field. Referring to FIG. 5-7, the helical antenna helically spirals upwardly from ground plane member 62 so that a free end 68 of the antenna element sits above the member 62. The helical antenna element 64 is encased within a foam body 70 with the ground end 66 exposed and free to be soldered or otherwise electrically and possibly physical coupled to the ground plane member 62. The foam body 70 protects the antenna element 64 and aligns the helical bends along the longitudinal axis 60 of the antenna element.

One exemplary embodiment of the invention uses a helical antenna element in the form of a helical fractal antenna. The helical fractal antenna may be a fractal antenna commercially available from Fractal Antenna Systems, Incorporated of Bedford, Mass. Such helical fractal antennas are more compact than traditional helical antennas. The ground plane member 62 and ground end 66 of antenna element 64 are coupled to the processing circuitry 28 and a suitable ground reference via a suitable RF cable 72 or a similar coupling.

As illustrated in FIG. 5, helical antenna 26 is titled or angled with respect to the plane 49 defined by the bottom surface 58 of the housing. To that end, an interior mounting surface 48 extends at a tilt angle with respect to the bottom plane 49. The helical antenna 26, and particularly the ground plane member or board 62, is positioned on mounting surface 58, which thus angles the antenna 26. In one embodiment of the invention, the antenna might be angled or tilted at an angle ⊖ between 0-10 degrees. One suitable embodiment utilizes an antenna angled or tilted at ⊖=5 degrees with respect to the plane 49 defined by the bottom surface 48 of the housing of the RFID reader 10. Therefore, the antenna 26 is tilted or angled with respect to the surface of a user's arm wearing the RFID reader. As illustrated in FIG. 1, such an angled antenna provides a desired direction for RF field 20 for reading an RFID tag when a user picks up an item 14 wearing RFID reader 10 on their arm. The angled antenna of the invention orients and focuses the RF field 20 in the direction of the item held by the user and any RFID tag on the item. This increases the chances of a suitable read of the tag by the reader when the item is picked up and handled. Therefore, the invention reduces the need for separate scanning or movement of the RFID reader in the proximity of the tag as a separate step. The item is handled and the RFID tag is read or engaged all in one continuous step. As may be appreciated, this provides great efficiencies not recognized in other RFID readers.

In accordance with another aspect of the invention, the present invention incorporates an indexing structure for rotationally indexing the antenna at a desired rotational orientation in the housing. Generally, antennas, such as fractal helical antennas, will be affected by the elements near the antenna such as the housing and the other components. Therefore, the antenna needs to be seated correctly within the housing. As such, the present invention provides an ability to “tune” or otherwise orient the antenna of the invention to an optimal rotational orientation within housing 24 to provide a desired direction to RF field 20 for the RFID reader. The antenna of the invention includes an indexing structure with multiple angular positions around the periphery of the antenna. At least one key structure is positioned in the housing, and is configured for engaging the indexing structure at an angular position to orient the antenna at a desired rotational orientation in the housing, and thus tune the helical antenna and direct the RF field 20.

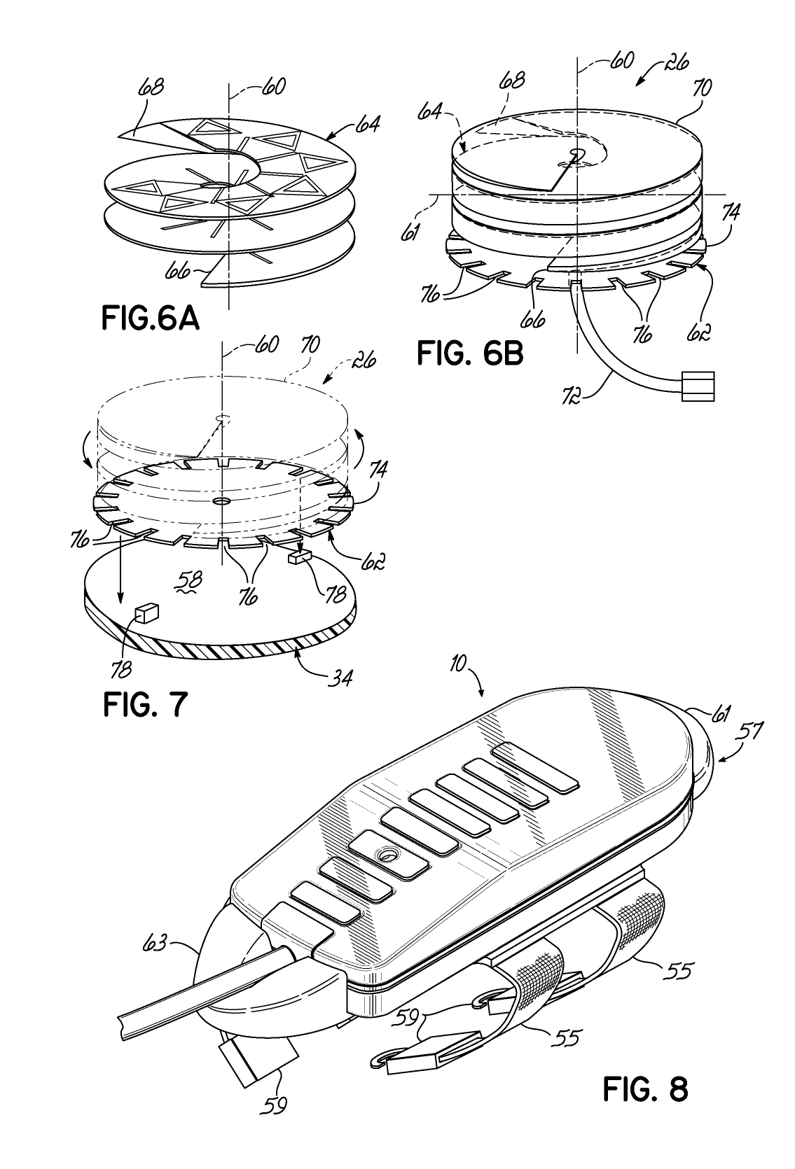

In one embodiment of the invention, the ground plane member 62 incorporates the indexing structure in the form of a plurality of slots 76 that are formed in the ground plane member 62. As illustrated in FIG. 6B, one embodiment of the helical antenna of the invention has a generally circular cross-section, as defined by the cross-sectional plane 61. To that end, the ground plane member 62 might also be circular in shape, and include the plurality of slots 76 formed around the circular periphery of the antenna and ground plane member 62. When using a circular helical antenna 26 to scan a certain pre-determined focus area for RFID tags, the rotational orientation of the helical antenna 26 affects the field 20, and thus, the performance of the reader. In the illustrated embodiment, the key structure 78 may be formed in the housing 24, such as on angled housing surface 58 to engage a particular slot of the indexing structure.

As illustrated in FIGS. 5 and 7, one suitable key structure includes a suitable-shaped tab or key 78, which is configured to engage one of the slots 76. One or more such key structures 78 may be utilized around the periphery of the antenna or the periphery of the ground plane member 62, and around the periphery of surface 58 at specific angular locations to line up with the slots 76. That is, multiple key structures 78 would engage multiple slots 76 simultaneously. In that way, the helical antenna 26 can be tuned to a rotational alignment that produces optimal scanning performance. Such an antenna orientation may be determined, and when the RFID reader is assembled, the helical antenna can be coupled to the mounting surface 58 by positioning one or more of the key structures 78 within appropriate slots 76 to angle the antenna, as desired in an optimal rotational orientation. Furthermore, depending upon the operation of the RFID reader, the antenna might be re-tuned by rotating the antenna and engaging different slots 76 of the indexing structure with the key structures 78. If a more permanent mounting of the antenna is desired upon the assembly of the RFID reader, the antenna 26, and particularly the ground plane member 62 might be more permanently fixed to housing surface 58, such as by being secured with an adhesive after it is tuned

In summary, the RFID reader 10 provides an angled helical antenna 26 that is also tuned to an optimal rotational orientation within housing 24 to scan for any RFID tags 12 on an item 14 held between a worker's hands 22 and arms 16. The housing 24 also includes a plurality of grip structures 56 to ergonomically assist the worker 16 in gripping and holding the item 14. Thus, the reader 10 automatically scans for and detects RFID tags 12 without additional arm movements over an item 14. The RFID reader 10 therefore improves upon conventional RFID readers and other identification information scanning devices.

The housing 24 defines an interior space for housing the electronics of the RFID reader, and also the antenna. The housing interior includes a space above mounting surface 58 for that antenna and an adjacent space for the processing circuitry 28. The helical antenna 26 is coupled to the mounting surface 58, as discussed above.

Referring to FIGS. 4, 5 and 5A, the processing circuitry 28 is supported on a suitable circuit board 29, which may be supported on a plurality of tabs 82, extending upwardly from the bottom surface of the housing. To secure board 29 in place, a post 86 cooperates with a fastener 84 on opposing sides of board 29. As may be appreciated, other securing structure methods might be utilized for securing the processing circuitry 28 and board 29 within housing 24.

Referring to FIG. 5A, reader 10 includes suitable processing circuitry 28, which includes a processor circuit 30, which may include one or more processor components for controlling the operation of the RFID reader 10. One suitable processor circuit 30 is an RFID module from ThingMagic of Cambridge, Mass. As will be appreciated by a person of ordinary skill in the art, the processor circuit 30 will operate according to an operating system, which is a software-implemented series of instructions. The processor may also run one or more application programs associated with RFID data collection or RFID writing. The processor circuit 30 is operably coupled with antenna 26 for the RFID operations.

The processing circuitry 28 also incorporates a suitable transceiver circuit 47 for coupling with antenna 26 to handle the transmit-and-receive signals for antenna 26 in accordance with the RFID reader operation. Transmit signals are transmitted by antenna 26 to an RFID tag, and the signals from the RFID tag are received by antenna 26, and directed through the transceiver 47 to be further processed. Transceiver circuit 47 is illustrated as a single element, however, it would be readily understood that, in such transceivers, there are often separate transmit-and-receive paths for handling the RF signals. A transceiver circuit may be any appropriate circuit for providing the RFID reader operation.

In various applications, the RFID reader 10 might be utilized with another electronic device, such as a portable computer device 31 that is able to further process data and information captured by the RFID reader 10. One suitable device for use with the reader 10 of the invention is a TALKMAN® wearable computer commercially available from Vocollect, Inc. of Pittsburgh, Pa. Portable computer device 31 may be configured to interface with a remote system 33, such as a central inventory system. Generally, the interface is a wireless interface 35, such as a WLAN connection.

In one embodiment of the invention, the RFID reader 10 might be coupled with the portable computer device 31 in a wired fashion by a suitable cable 35 (See FIG. 3). In such an embodiment, power is directed to processing circuitry 28 from the portable computer device to power the processing circuitry and its components, as well as antenna 26. In addition to providing power to the RFID reader 10, cable 35 might also be incorporated for transmitting data and other information captured by the reader back to portable computer device 31. In accordance with one possible embodiment of the invention, reader 10 might include an ultra capacitor or super capacitor 37 that is operable to store a charge from the power that is supplied by the portable computer device 31 to handle power surges when the antenna is powered for a read or write operation. Such ultracapacitors 37 may be optional and are commercially available. They provide an additional surge power supply for the processing circuitry 28 of reader 10. To protect the processing circuitry 28 from the RF field of antenna 26, an RF shield element 43 might be mounted to surround and shield sensitive processing circuitry components, as shown in FIG. 5.

In an alternative embodiment of the invention, reader 10 might be coupled with a portable computer device 31 by a wireless link. For example, a suitable wireless personal area network (WPAN) interface 39, such as a Bluetooth interface, might be utilized in RFID reader 10 for a wireless connection to portable computer device 31. In such an embodiment, the RFID reader 10 may have its own power supply, such as a battery 41, such as a lithium-ion battery. As will be understood by a person of ordinary skill in the art, processing circuitry 28 may include other components not discussed herein for the proper operation of RFID reader 10, and the present invention is not limited to a specific RFID reader circuitry or the specific operational aspects of the RFID reader methodology.

While the present invention has been illustrated by the description of the embodiment thereof, and while the embodiment has been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

What is claimed is:

1. An RFID reader configured to be worn on the arm of a user, the RFID reader comprising:
a housing including a bottom surface for facing the arm of a user and a top surface facing away from the arm,
a securement structure configured to engage the arm of the user to secure the housing to the arm;
an antenna having a directional RF field, the antenna mounted within the housing, the antenna being angled with respect to the bottom surface of the housing,
the angled antenna providing a directional RF field at an angle to the arm of a user to direct the RF field toward an item held by the arm to interact with an RFID tag on the item.

2. The RFID reader of claim 1, wherein the antenna is a helical antenna.

3. The RFID reader of claim 1 wherein the helical antenna comprises a helical fractal antenna.

4. The RFID reader of claim 1, wherein the housing bottom surface forms a plane, the antenna being angled with respect to the plane at an angle of around 5 degrees.

5. The RFID reader of claim 1, wherein the top surface includes an angled portion that is angled with respect to the bottom surface, the angled portion being angled with respect to the bottom surface similarly to the antenna.

6. The RFID reader of claim 1 further comprising at least one grip structure located along at least a portion of the top surface, the grip structure configured for gripping a surface of an item when it is held in the arms of a user.

7. The RFID reader of claim 1 wherein the securement structure includes at least one strap coupled to the housing, the strap configured to go around the arm of the user.

8. The RFID reader of claim 1 wherein the securement structure includes a frame structure configured to engage the arm of the user, the frame configured for removably coupling with the housing to secure the housing to the arm.

9. The RFID reader of claim 1, wherein the antenna includes a ground plane member, the ground plane member being angled with respect to the housing bottom surface to angle the antenna.

10. The RFID reader of claim 1, wherein the antenna includes a ground plane member, the ground plane member configured to engage the housing so that the antenna is disposed at a desired rotational orientation in the housing.

11. The RFID reader of claim 10, wherein the ground plane member includes a plurality of notches therein, the housing including at least one key structure for engaging at least one corresponding notch of the ground plane member when the antenna is mounted within the housing to orient the antenna in the housing.

12. The RFID reader of claim 1 further comprising an ultra capacitor coupled with the antenna for providing power to the antenna.

13. The RFID reader of claim 1, further comprising a WPAN interface for wirelessly communicating with another device.

14. An RFID reader comprising:
a housing;
an antenna having a directional RF field and mounted in the housing;
the antenna including an indexing structure with multiple angular positions for orientation of the antenna;
at least one key structure positioned in the housing and configured for engaging the indexing structure at an angular position around the antenna to orient the antenna at a desired rotational orientation in the housing to tune the antenna.

15. The RFID reader of claim 14 wherein the antenna includes a ground plane member, the indexing structure being on the ground plane member.

16. The RFID reader of claim 14 wherein the indexing structure includes a plurality of slots, the key structure engaging at least one slot formed around the antenna.

17. The RFID reader of claim 15 wherein the indexing structure includes a plurality of slots that are formed along a periphery of the ground plane member.

18. The RFID reader of claim 14 wherein the indexing structure includes a plurality of slots, and further comprising a plurality of key structures engaging a plurality of slots around the ground plane member.

19. The RFID reader of claim 14, wherein the antenna is a helical antenna.

20. The RFID reader of claim 19, wherein the helical antenna comprises a helical fractal antenna.

21. The RFID reader of claim 14, wherein the housing has a bottom surface for facing the arm of a user and a top surface facing away from the arm and the antenna is angled with respect to the bottom surface of the housing.

22. The RFID reader of claim 20, wherein the housing bottom surface forms a plane, the antenna being angled with respect to the plane at an angle of around 5 degrees.

23. An antenna arrangement for use in an RFID reader, the antenna comprising:
a ground plane member;
an indexing structure configured in the ground plane member at multiple angular positions around the ground plane member;
at least one key structure configured for engaging the indexing structure at an angular position around the ground plane member to orient the antenna at a desired rotational orientation in an RFID reader.

24. The antenna arrangement of claim 22 wherein the indexing structure includes a plurality of slots formed in the ground plane member, the key structure engaging at least one slot.

25. The antenna arrangement of claim 23 wherein the slots are formed along a periphery of the ground plane member.

26. The antenna arrangement of claim 22 further comprising a plurality of key structures engaging the indexing structure at plurality of angular positions around the ground plane member.

27. The antenna arrangement of claim 23, wherein the antenna is a helical antenna.

28. The antenna arrangement of claim 27, wherein the helical antenna comprises a fractal antenna.

29. An RFID reader configured to be worn on the arm of a user, the RFID reader comprising:
a housing including a bottom surface for facing the arm of a user and a top surface facing away from the arm,
a securement structure configured to engage the arm of the user to secure the housing to the arm;
an antenna mounted within the housing,
at least one of grip structure located on at least a portion of the top surface, the grip structure configured for gripping a surface of an item when it is held in the arms of a user.

30. The RFID reader of claim 29 further comprising a plurality of grip structures formed along at least a portion of the top surface.

31. The RFID reader of claim 29 wherein the securement structure includes at least one strap coupled to the housing, the strap configured to go around the arm of the user.

32. The RFID reader of claim 29 wherein the securement structure includes a frame configured to engage the arm of the user, the frame configured for removably coupling with the housing to secure the housing to the arm.

33. The RFID reader of claim 29 wherein the grip structure is formed of an elastomer material.

34. The RFID reader of claim 29 wherein the housing includes a top housing portion defining the top surface, the top housing portion including a lower section and an upper section that overlies the lower section to form the top housing portion, at least one of the lower and upper sections being formed of a thermoplastic elastomer.

35. The RFID reader of claim 34 wherein the grip structures are formed on the lower section and extend through openings in the overlying upper section to be located on at least a portion of the top surface.
